(19) United States
(12) Patent Application Publication
(10) Pub. No.: US 2023/0242439 A1
(43) Pub. Date: Aug. 3, 2023

(54) REINFORCED CRYSTALLIZED GLASS

(71) Applicant: OHARA INC., KANAGAWA (JP)

(72) Inventors: KOHEI OGASAWARA, KANAGAWA (JP); TOSHITAKA YAGI, KANAGAWA (JP)

(21) Appl. No.: 18/011,187

(22) PCT Filed: Jun. 7, 2021
(86) PCT No.: PCT/JP2021/021477

§ 371 Date: Dec. 18, 2022

(30) Foreign Application Priority Data
Jun. 19, 2020 (JP) 2020-105746

(51) Int. Cl. C03C 10/00; C03C 21/00

(52) U.S. Cl. CPC C03C 10/0045; C03C 10/0054; C03C 21/002; C03C 2204/00

(57) ABSTRACT

Reinforced crystallized glass characterized including crystallized glass as a base material, the crystallized glass containing, as expressed in terms of mol % on an oxide basis, 30.0% to 70.0% of an SiO₂ component, 8.0% to 25.0% of an Al₂O₃ component, 2.0% to 25.0% of an Na₂O component, 1.0% to 6.0% of an Li₂O component, 0 % to 25.0% of an MgO component, 0% to 30.0% of a ZnO component, and 0% to 10.0% of a TiO₂ component, in which a surface of the reinforced crystallized glass is formed with a compressive stress layer, and a depth (DOLzero) of the compressive stress layer is 60 μm or more.

### FIELD OF THE DISCLOSURE

The present disclosure relates to a reinforced crystallized glass including a surface formed thereon with a compressive stress layer.

### BACKGROUND OF THE DISCLOSURE

A cover glass for protecting a display is used in a portable electronic device such as a smartphone and a tablet PC. A protector for protecting a lens is also used in an in-vehicle optical device. In recent years, there is a demand for a use in a housing or the like serving as an exterior of an electronic device. There is an increasing demand for a material having a high strength so that such a device can withstand a severe use.

Conventionally, chemically reinforced glass is employed as a material for use in a protective member and the like. However, there are many cases where a conventional chemically reinforced glass breaks when a mobile device such as a smartphone is dropped, resulting in a problem.

For example, Patent Document 1 discloses high-strength crystallized glass and a chemically reinforced version of such high-strength crystallized glass. However, to further expand the use of crystallized glass as an exterior of an electronic device, there is a demand for crystallized glass with higher strength, in particular, crystallized glass that does not easily break when dropped onto a rough, uneven surface such as asphalt.

### Prior Art Document

### [Patent Document]

[Patent Document 1] Japanese Patent Application Publication No. 2017-001937

### SUMMARY OF THE DISCLOSURE

An object of the present disclosure is to provide reinforced crystallized glass that hardly brakes when being dropped onto a rough surface.

As a result of intensive research to solve the above problems, the present inventors have found that, if crystallized glass containing a predetermined amount of lithium is chemically reinforced under a predetermined condition, a chemically reinforced crystallized glass is obtained that hardly brakes when being dropped onto a rough surface, which led to the completion of the present disclosure. Patent Document 1 describes crystallized glass that may contain lithium as a constituent component. However, lithium is not easy to handle, and if contained, the glass may easily devitrify, and thus, typically, lithium is not necessarily contained. Sodium is included as a constituent component of the crystallized glass and the crystallized glass is chemically reinforced by using a potassium salt bath. Contents of the present disclosure are specifically described below.

(Configuration 1) A reinforced crystallized glass including a crystallized glass as a base material, the crystallized glass containing, as expressed in terms of mol % on an oxide basis,

30.0% to 70.0% of an SiO₂ component,
8.0% to 25.0% of an Al₂O₃ component,
2.0% to 25.0% of an Na₂O component,
1.0% to 6.0% of an Li₂O component,
0% to 25.0% of an MgO component,
0% to 30.0% of a ZnO component, and
0% to 10.0% of a TiO₂ component,
in which a surface of the reinforced crystallized glass is formed with a compressive stress layer, and
a depth (DOLzero) of the compressive stress layer is 60 μm or more.

(Configuration 2) The reinforced crystallized glass according to Configuration 1, in which a value of a total content of the MgO component and the ZnO component is 1.0% or more and 30.0% or less, as expressed in terms of mol % on an oxide basis.

(Configuration 3) The reinforced crystallized glass according to Configuration 1 or 2, in which the crystallized glass contains, as expressed in terms of mol % on an oxide basis,

0% to 25.0% of a B₂O₃ component,
0% to 10.0% of a P₂O₅ component,
0% to 20.0% of a K₂O component,
0% to 10.0% of a CaO component,
0% to 10.0% of a BaO component,
0% to 8.0% of a FeO component,
0% to 10.0% of a ZrO₂ component, and
0% to 5.0% of an SnO₂ component.

(Configuration 4) The reinforced crystallized glass according to any one of Configurations 1 to 3, in which the crystallized glass includes, as expressed in terms of mol % on an oxide basis,

0% to 10.0% of an SrO component,
0% to 3.0% of an La₂O₃ component,
0% to 3.0% of a Y₂O₃ component,
0% to 5.0% of an Nb₂O₅ component,
0% to 5.0% of a Ta₂O₅ component, and
0% to 5.0% of a WO₃ component.

(Configuration 5) The reinforced crystallized glass according to any one of Configurations 1 to 4, in which a content of the B₂O₃ component in the crystallized glass is 0.0% or more and less than 2.0%, as expressed in terms of mass % on an oxide basis.

(Configuration 6) The reinforced crystallized glass according to any one of Configurations 1 to 5, in which a value of a molar ratio [TiO₂/Na₂O] of the TiO₂ component relative to the Na₂O component is 0 or more and 0.41 or less, as expressed in terms of mol % on an oxide basis.

(Configuration 7) The reinforced crystallized glass according to any one of Configurations 1 to 6, in which a surface compressive stress value (CS) of the compressive stress layer is 800 MPa or more.

According to the present disclosure, it is possible to obtain reinforced crystallized glass that hardly brakes when being dropped onto a rough surface.

The reinforced crystallized glass according to the present disclosure may be used for a protective member and the like of a device by taking advantage of a feature that high strength is provided. The reinforced crystallized glass according to the present disclosure may be utilized as a cover glass or a housing of a smartphone, a member of a portable electronic device such as a tablet PC and a wearable terminal, and a protective protector, a member of a substrate for a head-up display, or the like used in a transport vehicle such as a car and an airplane. The reinforced crystallized glass according to the present disclosure may be used for other electronic devices and machinery, a building member, a member for a solar panel, a member for a projector, and a cover glass (windshield) for eyeglasses and a watch, for example.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art.

Crystallized glass is also called glass-ceramics, and is a material obtained by subjecting glass to heat treatment to precipitate crystals inside the glass. Generally, the crystalline phase of the crystallized glass is determined by using a peak angle appearing in an X-ray diffraction pattern in X-ray diffraction analysis, and by using TEMEDX if necessary.

The reinforced crystallized glass of the present disclosure includes, as a crystalline phase, for example, one or more selected from RAl₂O₄, RTi₂O₄, RTi₂O₅, R₂TiO₄, R₂SiO₄, RAl₂Si₂O₈, R₂Al₄Si₅O₁₈, R₂TiO₅, RSiO₃ , and NaAlSiO₄ (note that R is one or more selected from Zn, Mg, and Fe), and solid solutions thereof. Preferably, the above crystalline phase is used as a main crystalline phase. When the above crystalline phase is included, it is possible to obtain crystallized glass having high mechanical strength. In the present disclosure, a lithium silicate crystalline phase and a petalite crystalline phase (LiAlSi₄O₁₀) may not be used as the main crystalline phase. The main crystalline phase is a crystalline phase having more wt % than the other crystalline phases.

When the content of a constituent component of the crystallized glass is described, “in terms of mol % or mass % on an oxide basis” means, if it is assumed that all the constituent components included in the crystallized glass are dissolved and converted into oxides, when a total amount of the oxides is 100 mol % or 100 mass %, an amount of oxides in each of the components contained in the crystallized glass is expressed by mol % or mass %. As used herein, a content of each component is expressed by “in terms of mol % on an oxide basis”, unless otherwise specified.

As used herein, “A % to B %” represents A % or more and B % or less. Further, “0%” in “containing 0% to C %” refers to a content of 0%.

Chemical reinforcing is a method of exchanging, on a surface of the glass, alkali ions contained in the glass with other alkali ions to generate compressive stress to reinforce the surface of the glass. The present inventors found that, if the glass contains a predetermined amount of lithium which first mainly ion-exchanges with sodium ions and then mainly ion-exchanges with potassium ions, the strength of the chemically reinforced glass when dropped onto a rough surface such as asphalt increases. The present inventors consider that such an improvement in strength is realized as follows, with a focus on an ionic radius of alkali ions. The ionic radius of lithium ions is 0.60 Å, the ionic radius of sodium ions is 0.95 Å, and the ionic radius of potassium ions is 1.33 Å. If lithium ions having a small ionic radius are present in the glass, the lithium ions are ion-exchanged to sodium ions in a region deeper from the surface than other alkali ions. That is, it is possible to form a compressive stress layer formed from the surface of the glass to a region deep within the glass. Thereafter, when the sodium ions are replaced with potassium ions having a larger ionic radius, the compressive stress on the surface of the compressive stress layer increases. At this time, ion exchange with potassium ions is considered to occur near the surface of the compressive stress layer and not in a deep region where lithium ions are ion-exchanged. Therefore, the component constituting the crystallized glass (the crystallized glass to be reinforced), which is a base material used in the present disclosure, characteristically contains at least a predetermined amount of lithium as an alkali metal component.

A composition range of each component constituting the crystallized glass, which serves as the base material of the reinforced crystallized glass of the present disclosure, will be specifically described below.

The SiO₂ component is an essential component forming a glass network structure of the crystallized glass. If the amount of the SiO₂ component is less than 30.0%, the obtained glass has poor chemical durability and poor devitrification resistance. Therefore, the lower limit of the content of the SiO₂ component is preferably 30.0% or more, more preferably 40.0% or more, and most preferably 50.0% or more.

On the other hand, when the content of the SiO₂ component is 70.0% or less, it is possible to suppress an excessive increase in viscosity and a deterioration of the meltability. Therefore, the upper limit of the content of the SiO₂ component is preferably 70.0% or less, more preferably 68.0% or less, still more preferably 66.5% or less, and most preferably 65.0% or less.

Similarly to SiO₂, the Al₂O₃ component is an essential component that forms the glass network structure and may serve as a component constituting a crystalline phase by heat treatment of raw glass yet to be crystallized. Although the Al₂O₃ component contributes to the stabilization of raw glass and an improvement in chemical durability, the effect is poor if the amount of the Al₂O₃ component is less than 8.0%. Therefore, the lower limit of the content of the Al₂O₃ component is preferably 8.0% or more, more preferably 9.0% or more, and most preferably 10.0% or more.

On the other hand, when the content of the Al₂O₃ component exceeds 25.0%, the meltability and the devitrification resistance deteriorate. Therefore, the upper limit of the content of the Al₂O₃ component is preferably 25.0% or less, more preferably 20.0% or less, still more preferably 17.0% or less, and most preferably 15.0% or less.

The Na₂O component is an essential component involved in chemical reinforcing and improving low-temperature meltability and formability.

On the other hand, when the content of the Na₂O component is 25.0% or less, it is possible to suppress deterioration of the chemical durability and a rise of an average linear expansion coefficient caused by an excessive content of the Na₂O component. Thus, the upper limit of the content of the Na₂O component is preferably 25.0% or less, more preferably 20.0% or less, and most preferably 15.0% or less.

In performing the chemical reinforcing by the ion exchange, Na⁺ ions from the Na₂O component contained in the crystallized glass are exchanged with K⁺ ions and contribute to the formation of the compressive stress layer. The lower limit of the content of the Na₂O component is preferably 2.0% or more, more preferably 4.0% or more, still more preferably 6.0% or more, even more preferably 8.0% or more, and most preferably 8.5% or more. Further, the lower limit of the content of the Na₂O component is preferably 7.0% or more, more preferably 9.0% or more, still more preferably more than 10.0%, and most preferably 10.1% or more in terms of mass % on an oxide basis.

The Li₂O component is an essential component involved in chemical reinforcing and improving low-temperature meltability and formability of the glass.

On the other hand, if the Li₂O component is excessively contained, the glass easily devitrifies significantly. Therefore, the upper limit of the content of the Li₂O component is preferably 6.0% or less, more preferably 5.0% or less, still more preferably 4.0% or less, and most preferably 3.5% or less.

In performing the chemical reinforcing by the ion exchange, if the Li₂O component is contained in the crystallized glass, it is possible to effectively form the compressive stress layer in a deep region of the glass. Therefore, the lower limit of the content of the Li₂O component is preferably 1.0% or more, more preferably 1.1% or more, still more preferably 1.2% or more, and most preferably 1.3% or more.

The MgO component is one of the components that may constitute the crystalline phase and is an optional component. The optional component may or may not be contained. The content of the MgO component may be 0% or more. If the MgO component is contained in an amount exceeding 0%, it is possible to obtain an effect of improving the low-temperature meltability. Therefore, the lower limit of the content of the MgO component may preferably be more than 0%, more preferably 5.0% or more, and still more preferably 8.0% or more.

On the other hand, when the content of the MgO component is 25.0% or less, it is possible to suppress deterioration in devitrification resistance caused by an excessive content of the MgO component. Thus, the upper limit of the content of the MgO component is preferably 25.0% or less, more preferably 20.0% or less, and most preferably 15.0% or less.

The ZnO component is one of the components that may constitute the crystalline phase and is an optional component. If the content of the ZnO component exceeds 0%, it is possible to obtain an effect of improving the low-temperature meltability and the chemical durability.

On the other hand, when the content of the ZnO component is 30.0% or less, it is possible to prevent a deterioration of devitrification properties. Therefore, the upper limit of the content of the ZnO component is preferably 30.0% or less, more preferably 15.0% or less, still more preferably 10.0% or less, and most preferably 5.0% or less.

The TiO₂ component is an optional component that contributes to forming nuclei for precipitating crystals and also contributes to lowering the viscosity and improving the chemical durability of the crystallized glass. The lower limit of the content of the TiO₂ component may preferably be more than 0%, more preferably 0.5% or more, still more preferably 1.0% or more, and most preferably 1.5% or more.

On the other hand, when the content of the TiO₂ component is 10.0% or less, it is possible to prevent a deterioration of the devitrification properties. Therefore, the upper limit of the content of the TiO₂ component is preferably 10.0% or less, more preferably 8.0% or less, still more preferably 6.0% or less, and most preferably 5.0% or less.

While providing excellent devitrification resistance during melting, in order to precipitate crystals, it is preferable that the molar ratio of the TiO₂ component relative to the Na₂O component, that is, a value of [TiO₂/Na₂O] is in a range of 0 or more and 0.41 or less in terms of mol % on an oxide basis. The lower limit of the value of [TiO₂/Na₂O] is preferably 0 or more, more preferably 0.05 or more, still more preferably 0.10 or more, and most preferably 0.12 or more. Similarly, the upper limit of the value of [TiO₂/Na₂O] is preferably 0.41 or less, and more preferably 0.40 or less.

In the present disclosure, to obtain the above-mentioned crystalline phase while providing excellent meltability and formability, the total content of the MgO component and the ZnO component, that is, a value of [MgO+ZnO], is preferably in a range of 1.0% or more and 30.0% or less in terms of mol % on an oxide basis. The lower limit of the value of [MgO+ZnO] is preferably 1.0% or more, more preferably 5.0% or more, still more preferably 10.0% or more, and most preferably 12.0% or more. Similarly, the upper limit of the value of [MgO+ZnO] is preferably 30.0% or less, more preferably 20.0% or less, still more preferably 18.0% or less, even more preferably 17.0% or less, and most preferably 16.0% or less.

If the content of the B₂O₃ component exceeds 0%, it is possible to contribute to lowering the viscosity of the glass and improve the meltability and the formability of the glass, and thus, the B₂O₃ component can be added as an optional component.

On the other hand, if the B₂O₃ component is excessively contained, the chemical durability of the crystallized glass easily decreases, and the precipitation of crystals is easily suppressed. Therefore, the upper limit of the content of the B₂O₃ component is preferably 25.0% or less, more preferably 10.0% or less, still more preferably 5.0% or less, and most preferably less than 2.0%. The content of the B₂O₃ component may be from 0.0% to less than 2.0% or from 0.0% to 1.0% in terms of mass % on an oxide basis.

The P₂O₅ component is an optional component that contributes to the improvement of the low-temperature meltability of the glass, if the content of the P₂O₅ component exceeds 0%.

On the other hand, if the P₂O₅ component is excessively contained, the devitrification resistance is likely to decrease and phase separation easily occurs in the glass. Therefore, the upper limit of the content of the P₂O₅ component is preferably 10.0% or less, more preferably 7.0% or less, still more preferably 5.0% or less, even more preferably 4.0% or less, and most preferably 3.0% or less. The lower limit of the P₂O₅ component is 0% or more, more preferably more than 0%, and still more preferably 0.5% or more.

The K₂O component is an optional component that contributes to the improvement of the low-temperature meltability and the formability of the glass.

On the other hand, if the K₂O component is excessively contained, the chemical durability is likely to deteriorate and an average linear expansion coefficient easily increases. Therefore, the upper limit of the content of the K₂O component is preferably 20.0% or less, more preferably 10.0% or less, still more preferably 5.0% or less, and most preferably less than 2.0%. The lower limit of the content of the K₂O component is preferably 0% or more, more preferably more than 0%, still more preferably 0.5% or more, even more preferably 0.8% or more, and most preferably 1.0% or more.

The CaO component is an optional component that contributes to the improvement of the low-temperature meltability of the glass, if the content of the CaO component exceeds 0%.

On the other hand, if the CaO component is excessively contained, the devitrification resistance easily decreases. Therefore, the upper limit of the content of the CaO component is preferably 10.0% or less, more preferably 7.0% or less, still more preferably 5.0% or less, yet still more preferably 4.0% or less, even more preferably 3.0% or less, still even more preferably 1.2% or less, and most preferably 1.0% or less. The lower limit of the content of the CaO component is 0% or more, more preferably more than 0%, and still more preferably 0.5% or more.

The BaO component is an optional component that contributes to the improvement of the low-temperature meltability of the glass, if the content of the BaO component exceeds 0%.

On the other hand, if the BaO component is excessively contained, the devitrification resistance easily decreases. Therefore, the upper limit of the content of the BaO component is preferably 10.0% or less, more preferably 5.0% or less, still more preferably 4.0% or less, even more preferably 3.0% or less, and most preferably 1.0% or less. The lower limit of the content of the BaO component is 0% or more, more preferably more than 0%, and still more preferably 0.5% or more.

The FeO component is one of the components that may constitute the crystalline phase, and may be optionally contained to serve as a clarifying agent.

On the other hand, if the FeO component is excessively contained, excessive coloration easily occurs and the platinum used in a glass melting device is easily alloyed. Therefore, the upper limit of the content of the FeO component is preferably 8.0% or less, more preferably 5.0% or less, still more preferably 3.0% or less, and most preferably 1.0% or less. The lower limit of the content of the FeO component is preferably 0% or more, more preferably more than 0%, and still more preferably 0.5% or more.

The ZrO₂ component is an optional component that may contribute to forming nuclei for precipitating crystals and also contributes to improving the chemical durability of the glass. Therefore, the lower limit of the content of the ZrO₂ component may preferably be 0% or more, and may preferably be more than 0%, more preferably 0.4% or more, even more preferably 0.8% or more, and most preferably 1.0% or more.

On the other hand, if the ZrO₂ component is excessively contained, the devitrification resistance of the glass easily decreases. Therefore, the upper limit of the content of the ZrO₂ component is preferably 10.0% or less, more preferably 4.0% or less, still more preferably 2.0% or less, and most preferably 1.5% or less.

The SnO₂ component is an optional component that may serve as a clarifying agent and may contribute to forming nuclei for precipitating crystals. Therefore, the lower limit of the content of the SnO₂ component may preferably be 0% or more, and may preferably be more than 0%, more preferably 0.01% or more, and most preferably 0.05% or more.

On the other hand, if the SnO₂ component is excessively contained, the devitrification resistance of the glass easily decreases. Therefore, the upper limit of the content of the SnO₂ component is preferably 5.0% or less, more preferably 1.0% or less, still more preferably 0.4% or less, and most preferably 0.2% or less.

The SrO component is an optional component that improves the low-temperature meltability of the glass, if the content of the SrO component exceeds 0%.

On the other hand, if the SrO component is excessively contained, the devitrification resistance easily decreases. The upper limit of the content of the SrO component is preferably 10.0% or less, more preferably 7.0% or less, still more preferably 5.0% or less, yet still more preferably 4.0% or less, even more preferably 3.0% or less, and most preferably 1.0% or less. The lower limit of the content of the SrO component is 0% or more, more preferably more than 0%, and still more preferably 0.5% or more.

The La₂O₃ component is an optional component that improves the mechanical strength of the crystallized glass, if the content of the La₂O₃ component exceeds 0%.

On the other hand, if the La₂O₃ component is excessively contained, the devitrification resistance easily decreases. Thus, the upper limit of the content of the La₂O₃ component is preferably 3.0% or less, more preferably 2.0% or less, and most preferably 1.0% or less. The lower limit of the content of the La₂O₃ component is 0% or more, more preferably more than 0%, and still more preferably 0.5% or more.

The Y₂O₃ component is an optional component that improves the mechanical strength of the crystallized glass, if the content of the Y₂O₃ component exceeds 0%.

On the other hand, if the Y₂O₃ component is excessively contained, the devitrification resistance easily decreases. Thus, the upper limit of the content of the Y₂O₃ component is preferably 3.0% or less, more preferably 2.0% or less, and most preferably 1.0% or less.

The Nb₂O₅ component is an optional component that improves the mechanical strength of the crystallized glass, if the content of the Nb₂O₅ component exceeds 0%.

On the other hand, if the Nb₂O₅ component is excessively contained, the devitrification resistance easily decreases. Thus, the upper limit of the content of the Nb₂O₅ component is preferably 5.0% or less, more preferably 2.0% or less, and most preferably 1.0% or less.

The Ta₂O₅ component is an optional component that improves the mechanical strength of the crystallized glass, if the content of the Ta₂O₅ component exceeds 0%.

On the other hand, if the Ta₂O₅ component is excessively contained, the devitrification resistance easily decreases. Therefore, the upper limit of the content of the Ta₂O₅ component is preferably 5.0% or less, more preferably 2.0% or less, and most preferably 1.0% or less.

The WO₃ component is an optional component that improves the mechanical strength of the crystallized glass, if the content of the WO₃ component exceeds 0%.

On the other hand, if the WO₃ component is excessively contained, the devitrification resistance easily decreases. Thus, the upper limit of the content of the WO₃ component is preferably 5.0% or less, more preferably 2.0% or less, and most preferably 1.0% or less.

The crystallized glass may optionally contain a Gd₂O₃ component and a TeO₂ component. The content of each of the Gd₂O₃ component and the TeO₂ component may be from 0% to 2.0%, or from 0.5% to 1.0%.

The crystallized glass may contain, as a clarifying agent, from 0% to 2.0%, preferably from 0.005% to 1.0%, and more preferably from 0.01% to 0.5% of one or more selected from an Sb₂O₃ component, an SnO₂ component, and a CeO₂ component.

Other components not described above may be added to the crystallized glass, if necessary, as long as the characteristics of the reinforced crystallized glass according to the present disclosure are not impaired.

There is a tendency to avoid the use of components including Pb, Th, Cd, Tl, Os, Be, and Se, which are considered in recent years to be harmful chemical substances, and therefore, it is preferable that such components are substantially not contained.

The above-mentioned blending amounts may be appropriately combined.

A total content of the SiO₂ component, the Al₂O₃ component, the Na₂O component, the Li₂O component, the MgO component, the ZnO component, and the TiO₂ component may be 85.0% or more, 90.0% or more, 95.0% or more, or 97.0% or more.

The reinforced crystallized glass of the present disclosure has a compressive stress layer on the surface of such glass when chemical reinforcing is applied. Assuming that an outermost surface has a depth of zero, the compressive stress of the outermost surface (surface compressive stress) is CS. DOLzero denotes a depth of the compressive stress layer when the compressive stress is 0 MPa.

The surface compressive stress value (CS) of the compressive stress layer is preferably 800 MPa or more. If the compressive stress layer has such a surface compressive stress value, it is possible to prevent a crack from developing to allow the mechanical strength to increase. The compressive stress value of the surface compressive stress layer may be 800 MPa or more, 900 MPa or more, 1000 MPa or more, 1010 MPa or more, or 1140 MPa or more.

On the other hand, the upper limit of the compressive stress value may be 1300 MPa or less, or 1280 MPa or less.

A central tensile stress value (CT) is preferably 25 MPa or more. If the compressive stress layer has such a central tensile stress value, it is possible to prevent a crack from developing to allow the mechanical strength to increase. The lower limit of the central tensile stress value may be 25 MPa or more, 27 MPa or more, 30 MPa or more, or 32 MPa or more.

On the other hand, the upper limit of the central tensile stress value may be 80 MPa or less, 70 MPa or less, or 60 MPa or less.

The depth (DOLzero) of the compressive stress layer is preferably 60 μm or more. When the compressive stress layer has such a depth, even if a deep crack occurs in the reinforced crystallized glass, it is possible to prevent the crack from developing and a substrate from being broken. The lower limit of the depth of the compressive stress layer may be 60 μm or more, 70 μm or more, 75 μm or more, 80 μm or more, or 110 μm or more.

The crystallized glass of the present disclosure preferably has a CT/DOLzero ratio from 0.10 to 0.90. As a result, the glass maintains high mechanical strength, and at the same time, when the glass is broken, pieces are less likely to be shredded into small fragments.

The lower limit of the CT/DOLzero ratio may be 0.10 or more, 0.20 or more, or 0.30 or more.

On the other hand, the upper limit of the CT/DOLzero ratio may be 0.90 or less, 0.80 or less, or 0.70 or less.

In the reinforced crystallized glass of the present disclosure, the product of CT×DOLzero is preferably from 1500 to 10000. As a result, even if a deep crack occurs in the reinforced crystallized glass, it is possible to prevent the crack from developing.

The lower limit of the product of CT×DOLzero may be 1500 or more, 2000 or more, 2300 or more, or 2500 or more.

On the other hand, the upper limit of the product of CT×DOLzero may be 10000 or less, 8000 or less, 7500 or less, or 7300 or less.

The crystallized glass of the present disclosure preferably has a CS/CT ratio from 10 to 50. As a result, the glass maintains high mechanical strength, and at the same time, when the glass is broken, pieces are less likely to be shredded into small fragments.

The lower limit of the CS/CT ratio may be 10 or more, 13 or more, or 15 or more.

On the other hand, the upper limit of the CS/CT ratio may be 50 or less, 45 or less, or 40 or less.

The crystallized glass of the present disclosure preferably has a DOLzero/T ratio (%) from 8.0% to 23%. T denotes a thickness (mm) of a crystallized glass substrate. As a result, even if a deep crack occurs in the reinforced crystallized glass, it is possible to prevent the crack from developing.

The lower limit of the DOLzero/T ratio (%) may be 8.0% or more, 9.0% or more, 10.0% or more, or 11.0% or more.

On the other hand, the upper limit of the DOLzero/T ratio (%) may be 23.0% or less, 20.0% or less, 19.0% or less, or 18.0% or less.

The lower limit of the thickness of the reinforced crystallized glass substrate is preferably 0.10 mm or more, more preferably 0.20 mm or more, still more preferably 0.40 mm or more, yet still more preferably 0.50 mm or more, and the upper limit of the thickness of the reinforced crystallized glass is preferably 1.00 mm or less, more preferably 0.90 mm or less, still more preferably 0.80 mm or less, and yet still more preferably 0.70 mm or less.

In a sandpaper drop test performed in Examples of the reinforced crystallized glass, it is desired that the height of the glass is preferably 70 cm or more, more preferably 80 cm or more, and still more preferably 90 cm. When such impact resistance is provided, the reinforced crystallized glass withstands an impact generated when dropped if used as a protective member.

The reinforced crystallized glass of the present disclosure may be produced by the following method, for example.

A raw material is evenly mixed and the prepared mixture is fed into a crucible made of platinum or quartz. The fed material is melted and stirred in an electric furnace or a gas furnace in a temperature range from 1300° C. to 1540° C. according to a degree of meltability of a glass composition, to homogenize the material. Thereafter, the resultant material is formed and slowly cooled down to manufacture raw glass. Next, the raw glass is crystallized to manufacture crystallized glass. The crystallized glass, used as a base material, may be chemically reinforced to form a compressive stress layer.

The raw glass is subjected to heat treatment to precipitate crystals in the glass. The heat treatment may be performed at a one-stage temperature or a two-stage temperature.

The two-stage heat treatment includes a nucleation step of firstly treating the raw glass by heat at a first temperature and a crystal growth step of treating, after the nucleation step, the glass by heat at a second temperature higher than that in the nucleation step.

In the one-stage heat treatment, the nucleation step and the crystal growth step are continuously performed at the one-stage temperature. Typically, the temperature is raised to a predetermined heat treatment temperature, is maintained for a certain period of time after reaching the predetermined heat treatment temperature, and is then lowered.

The first temperature of the two-stage heat treatment is preferably 600° C. to 750° C. A retention time at the first temperature is preferably 30 minutes to 2000 minutes, and more preferably 180 minutes to 1440 minutes.

The second temperature of the two-stage heat treatment is preferably 650° C. to 850° C. A retention time at the second temperature is preferably 30 minutes to 600 minutes, and more preferably 60 minutes to 300 minutes.

When the heat treatment is performed at the one-stage temperature, the heat treatment temperature is preferably 600° C. to 800° C., and more preferably 630° C. to 770° C. A retention time at the heat treatment temperature is preferably 30 minutes to 500 minutes, and more preferably 60 minutes to 300 minutes.

When the chemical reinforcing is performed, normally, a thin plate-shaped crystallized glass substrate is manufactured from the crystallized glass, by using for example, means such as grinding and polishing. Thereafter, the compressive stress layer is formed in the crystallized glass substrate via ion exchange by a chemical reinforcing method.

When the crystallized glass (base material) is chemical reinforced, it is preferable that the base material is contacted with or immersed in a salt bath (first salt bath) of a single molten salt of sodium salt (single bath) or a molten salt (mixed bath) containing potassium salt and sodium salt. Subsequently, the base material is contacted with or immersed in a salt bath (second salt bath) of a single molten salt of potassium salt (single bath) or a molten salt (mixed bath) containing potassium salt and sodium salt. The mixed molten salt used in the first salt bath preferably contains more sodium salt than potassium salt, and the mixed molten salt used in the second salt bath preferably contains more potassium salt than sodium salt.

As the potassium salt and the sodium salt, potassium nitrate (KNO₃), sodium nitrate (NaNO₃), and the like may be used. Specifically, in the first salt bath, for example, the crystallized glass base material is contacted with or immersed in sodium nitrate, or a mixed salt of potassium nitrate and sodium nitrate, or a molten salt of a complex salt thereof heated to 300 to 700° C. (preferably 350 to 600° C., more preferably 400 to 550° C.) for 100 minutes or more, for example, from 200 minutes to 900 minutes, preferably from 250 minutes to 800 minutes, and more preferably from 270 to 750 minutes. For example, in a ratio of potassium salt and sodium salt, potassium nitrate may be 0 parts by mass or more and less than 100 parts by mass, from 0 to 70 parts by mass, from 0 to 50 parts by mass, from 0 to 30 parts by mass, and from 0 to 10 parts by mass, when the mass of sodium nitrate is 100 parts by mass.

In the second salt bath, for example, the crystallized glass base material subjected to the first salt bath treatment is contacted with or immersed in potassium nitrate, or a mixed salt of potassium nitrate and sodium nitrate, or a molten salt of a complex salt thereof heated to 200 to 700° C. (preferably 300 to 600° C., more preferably 350 to 550° C.) for example, for 1 minute or more, from 3 minutes to 300 minutes, from 4 minutes to 200 minutes, or from 5 minutes to 150 minutes. For example, in a ratio of potassium salt and sodium salt, sodium nitrate may be from 0 to 70 parts by mass, from 0 to 50 parts by mass, from 0 to 30 parts by mass, from 0 to 10 parts by mass, and from 0 to 5 parts by mass, when the mass of potassium nitrate is 100 parts by mass.

With such chemical reinforcing, an ion exchange reaction between a component present near the surface and a component contained in the molten salt proceeds. As a result, the compressive stress layer is formed on a surface portion.

### EXAMPLES

### Examples 1 to 16 and Comparative Examples 1 and 2

1. Manufacture of Crystallized Glass

Raw materials such as oxides, hydroxides, carbonates, nitrates, fluorides, chlorides, and metaphosphate compounds corresponding to a raw material of each component of the crystallized glass were selected, and the selected raw materials were weighed and mixed uniformly to obtain the compositions (mol %) described in Table 1. In Table 1, crystallized glasses A to E are glasses used in Examples, and crystallized glasses F and G are glasses used in Comparative Examples.

Next, the mixed raw materials were fed into a platinum crucible and melted in an electric furnace in a temperature range from 1300° C. to 1540° C. depending on the degree of meltability of the glass composition. Subsequently, the molten glass was stirred and homogenized, cast into a mold, and slowly cooled to manufacture raw glass.

The obtained raw glass was treated for nucleation and crystallization under the crystallization conditions shown in Table 1. That is, one-stage heat treatment was performed to obtain the crystallized glasses A to F, and two-stage heat treatment was performed to obtain the crystallized glass G, to manufacture the crystallized glasses A to G as base materials. The obtained crystallized glasses were subject to lattice image observation by using an electron diffraction image, and analysis by EDX to observe crystalline phases of MgAl₂O₄ and MgTi₂O₅.

2. Na-Only Chemical Reinforcing of Crystallized Glass

The manufactured crystallized glasses A to G were cut and ground, and the opposing sides of such glasses A to G were further polished in parallel to achieve a thickness of 1 mm to obtain crystallized glass substrates.

Next, the crystallized glass substrates were immersed in a NaNO₃ salt bath at 490° C. for 500 minutes for chemical reinforcing, and surface conditions of the chemically reinforced substrates were observed. The surface conditions of the reinforced crystallized glasses F and G were rougher than those of the glass yet to be chemically reinforced, and in particular, the reinforced crystallized glass F was cracked. On the other hand, in the reinforced crystallized glasses A to E, no significant change from the surface conditions of the glass yet to be chemically reinforced was observed.

3. Two-Stage Chemical Reinforcing of Crystallized Glass

The crystallized glasses B to G were cut and ground, and the opposing sides of such glasses B to G were further polished in parallel to achieve thicknesses shown in Tables 2 to 4 to obtain a crystallized glass substrate. Next, the crystallized glass substrate was used as a base material to perform chemical reinforcing by using KNO₃ and NaNO₃ under the conditions shown in Tables 2 to 4. In the Tables, “Na only” indicates a molten salt containing only NaNO₃, “K only” indicates a molten salt containing only KNO₃, and “K:Na” indicates a mixed molten salt containing KNO₃ and NaNO₃ having a salt bath ratio of KNO₃:NaNO₃ (mass ratio). Specifically, for example, in Example 1, the crystallized glass substrate was immersed in a molten salt containing only NaNO₃ at 490° C. for 500 minutes, and thereafter, immersed in a molten salt containing only KNO₃ at 380° C. for 60 minutes.

4. Evaluation of Reinforced Crystallized Glass

The following measurements were performed on the reinforced crystallized glass substrate obtained by the above-described two-stage chemical reinforcing.

The results are shown in Tables 2 to 4.

### (1) Stress Measurement

The surface compressive stress value (CS) of the reinforced crystallized glass substrate was measured by using a glass surface stress meter FSM-6000LE series manufactured by Orihara Manufacturing Co., LTD. As a light source of the measurement device used in the CS measurement, a light source having a wavelength of 596 nm was selected. As the refractive index used in the CS measurement, a refractive index value at 596 nm was used. It is noted that the refractive index value at a wavelength of 596 nm was calculated by using a quadratic approximation expression from the measured values of the refractive index at the wavelengths of a C-line, a d-line, an F-line, and a g-line according to the V-block method specified in JIS B 7071-2: 2018.

A value of a photoelastic constant at a wavelength of 596 nm used for the CS measurement was calculated from the measured values of the photoelastic constants at a wavelength of 435.8 nm, a wavelength of 546.1 nm, and a wavelength of 643.9 nm by using a quadratic approximation expression.

A depth DOLzero (μm) and a central tensile stress (CT) when the compressive stress of the compressive stress layer was 0 MPa were measured by using a scattered light photoelastic stress meter SLP-1000. Regarding a wavelength of the measurement light source used for the DOLzero and the CT measurement, a light source having a wavelength of 640 nm was selected.

A value of a refractive index at 640 nm was used as a refractive index used in the DOLzero and the CT measurement. It is noted that the refractive index value at a wavelength of 640 nm was calculated by using a quadratic approximation expression from the measured values of the refractive index at the wavelengths of a C-line, a d-line, an F-line, and a g-line according to the V-block method specified in JIS B 7071-2: 2018.

A value of the photoelastic constant at 640 nm used for the DOLzero and the CT measurement used for the measurement was calculated from the measured values of the photoelastic constants at a wavelength of 435.8 nm, a wavelength of 546.1 nm, and a wavelength of 643.9 nm by using a quadratic approximation expression.

### (2) Sandpaper Drop Test

A drop test using sandpaper was performed by the following method. Such a drop test simulates a drop onto asphalt.

As a drop test sample, a reinforced crystallized glass substrate (length 150 mm×width 70 mm) was attached with a glass substrate having the same dimensions to obtain the drop test sample. It is noted that weights of all the drop test samples were 40 g. Sandpaper having a roughness of #80 was laid on a stainless steel base, and the above-described drop test sample was dropped onto the base from a height of 20 cm from the base with the reinforced crystallized glass substrate facing downward. After such dropping, as long as the substrate did not crack, the height of dropping was increased by 5 cm, and this was repeated until the substrate cracked. The test was performed three times (n1 to n3). The tables show a height at which a crack occurred, a maximum value (Max), a minimum value (Min), and an average value (Ave).

TABLE 1

| | Crystallized | Crystallized | Crystallized | Crystallized | Crystallized | Crystallized | Crystallized |
|---|---|---|---|---|---|---|---|
| mol % | glass A | glass B | glass C | glass D | glass E | glass F | glass G |
| SiO₂ | 58.001 | 58.305 | 58.077 | 57.238 | 59.329 | 57.99 | 55.16 |
| Al₂O₃ | 11.263 | 11.307 | 11.249 | 11.523 | 11.706 | 11.264 | 14.24 |
| Li₂O | 1.168 | 1.356 | 2.732 | 3.154 | 3.996 | 0 | 0.46 |
| Na₂O | 10.768 | 10.782 | 9.992 | 8.677 | 8.413 | 11.947 | 10.83 |
| K₂O | 1.625 | 1.514 | 1.281 | 1.935 | 1.131 | 1.627 | 1.82 |
| MgO | 12.432 | 12.416 | 12.404 | 13.251 | 10.914 | 12.431 | 5.95 |
| CaO | 0.965 | 0.969 | 0.955 | 0.898 | 1.118 | 0.97 | 0 |
| ZnO | 0 | 0 | 0 | 0 | 0.000 | 0 | 8.67 |
| TiO₂ | 3.759 | 3.332 | 3.291 | 3.305 | 3.380 | 3.752 | 1.59 |
| ZrO₂ | 0 | 0 | 0 | 0 | 0 | 0 | 1.28 |
| Sb₂O₃ | 0.019 | 0.019 | 0.019 | 0.019 | 0.013 | 0.019 | 0 |
| Total | 100.000 | 100.000 | 100.000 | 100.000 | 100.000 | 100.000 | 100.000 |
| TiO₂/Na₂O | 0.349 | 0.309 | 0.329 | 0.381 | 0.402 | 0.314 | 0.147 |
| MgO + ZnO | 12.432 | 12.416 | 12.404 | 13.251 | 10.914 | 12.431 | 14.620 |
| Crystallization | 695° C. | 665° C. | 655° C. | 655° C. | 655° C. | 705° C. | 1st 650° C. |
| conditions | 300 min | 300 min | 300 min | 300 min | 300 min | 300 min | 600 min |
| | | | | | | | 2nd 700° C. |
| | | | | | | | 120 min |

TABLE 2

| | | Example | Example | Example | Example | Example | Example | Example | Example |
|---|---|---|---|---|---|---|---|---|---|
| | | 1 | 2 | 3 | 4 | 5 | 6 | 7 | 8 |
| Crystallized glass | | Crystallized glass B | | | | | | | |
| Substrate thickness T | | 0.60 | 0.60 | 0.60 | 0.60 | 0.60 | 0.60 | 0.60 | 0.60 |
| (mm) | | | | | | | | | |
| 1st | Salt bath | Na only | Na only | Na only | Na only | K:Na = | K:Na = | K:Na = | K:Na = |
| Reinforcing | type | | | | | 1:2 | 1:2 | 1:3 | 1:3 |
| conditions | Salt bath | 490 | 450 | 490 | 450 | 490 | 450 | 490 | 490 |
| | temperature | | | | | | | | |
| | (° C.) | | | | | | | | |
| | Immersion | 500 | 300 | 500 | 300 | 500 | 700 | 600 | 300 |
| | time (min) | | | | | | | | |
| 2nd | Salt bath | K only | K only | K only | K:Na = | K only | K only | K only | K only |
| Reinforcing | type | | | | 90:1 | | | | |
| conditions | Salt bath | 380 | 400 | 400 | 450 | 380 | 380 | 450 | 400 |
| | temperature | | | | | | | | |
| | (° C.) | | | | | | | | |
| | Immersion | 60 | 15 | 30 | 30 | 60 | 120 | 15 | 15 |
| | time (min) | | | | | | | | |
| CS (MPa) | | 1043 | 1050 | 1109 | 1031 | 1130 | 1183 | 1035 | 984 |
| CT (MPa) | | 34 | 30 | 34 | 37 | 43 | 46 | 43 | 37 |
| DOLzero (μm) | | 104 | 88 | 105 | 76 | 74 | 67 | 78 | 89 |
| CT/DOLzero | | 0.327 | 0.341 | 0.324 | 0.487 | 0.581 | 0.687 | 0.551 | 0.416 |
| CS × DOLzero | | 3536 | 2640 | 3570 | 2812 | 3182 | 3082 | 3354 | 3293 |
| CS/CT | | 30.7 | 35.0 | 32.6 | 27.9 | 26.3 | 25.7 | 24.1 | 26.6 |
| DOLzero/T (%) | | 17.3 | 14.7 | 17.5 | 12.7 | 12.3 | 11.2 | 13.0 | 14.8 |
| Drop test | n1 | 110 | 115 | 95 | 110 | 95 | 90 | 115 | 105 |
| height (cm) | n2 | 135 | 90 | 90 | 85 | 85 | 75 | 90 | 100 |
| | n3 | 90 | 90 | 110 | 100 | 85 | 70 | 75 | 85 |
| | Max | 135 | 115 | 110 | 110 | 95 | 90 | 115 | 105 |
| | Min | 90 | 90 | 90 | 85 | 85 | 70 | 75 | 85 |
| | Ave | 112 | 98 | 98 | 98 | 88 | 78 | 93 | 97 |

TABLE 3

| | | Example 9 | Example 10 | Example 11 | Example 12 | Example 13 |
|---|---|---|---|---|---|---|
| Crystallized glass | | Crystallized | Crystallized glass C | | Crystallized | Crystallized glass |
| | | glass B | | | glass C | C |
| Substrate thickness T (mm) | | 0.60 | 0.78 | 0.68 | 0.68 | 0.68 |
| 1st Reinforcing | Salt bath type | K:Na = 1:10 | Na only | Na only | K:Na = 1:2 | K:Na = 1:1.5 |
| conditions | Salt bath | 530 | 490 | 490 | 470 | 470 |
| | temperature | | | | | |
| | (° C.) | | | | | |
| | Immersion | 500 | 500 | 500 | 400 | 400 |
| | time (min) | | | | | |
| 2nd Reinforcing | Salt bath type | K only | K only | K only | K:Na = 50:1 | K:Na = 80:1 |
| conditions | Salt bath | 450 | 380 | 380 | 400 | 420 |
| | temperature | | | | | |
| | (° C.) | | | | | |
| | Immersion | 30 | 60 | 60 | 90 | 90 |
| | time (min) | | | | | |
| CS (MPa) | | 1267 | 1227 | 1167 | 960 | |
| CT (MPa) | | 34 | 51 | 48 | 54 | 52 |
| DOLzero (μm) | | 83 | 139 | 116 | 118 | 108 |
| CT/DOLzero | | 0.410 | 0.367 | 0.414 | 0.458 | 0.481 |
| CS × DOLzero | | 2822 | 7089 | 5568 | 6372 | 5616 |
| CS/CT | | 37.3 | 24.1 | 24.3 | 17.8 | 19.8 |
| DOLzero/T (%) | | 13.8 | 17.8 | 17.1 | 17.4 | 15.9 |
| Drop test height | n1 | 70 | 105 | 110 | 105 | 85 |
| (cm) | n2 | 80 | 105 | 110 | 120 | 90 |
| | n3 | 105 | 125 | 130 | 105 | 85 |
| | Max | 105 | 125 | 130 | 120 | 95 |
| | Min | 70 | 105 | 110 | 105 | 85 |
| | Ave | 85 | 112 | 117 | 110 | 90 |

TABLE 4

| | | | | | Comparative | Comparative |
|---|---|---|---|---|---|---|
| | | Example 14 | Example 15 | Example 16 | Example 1 | Example 2 |
| Crystallized glass | | Crystallized | Crystallized | Crystallized | Crystallized | Crystallized |
| | | glass C | glass D | glass E | glass F | glass G |
| Substrate thickness T (mm) | | 0.55 | 0.68 | 0.55 | 0.60 | 0.68 |
| 1st Reinforcing | Salt bath type | K:Na = 1:2 | Na only | Na only | K:Na = 3:1 | K:Na = 3:1 |
| conditions | Salt bath | 470 | 490 | 470 | 490 | 490 |
| | temperature (° C.) | | | | | |
| | Immersion time | 260 | 500 | 400 | 600 | 600 |
| | (min) | | | | | |
| 2nd Reinforcing | Salt bath type | K:Na = 50:l | K only | K only | K only | K only |
| conditions | Salt bath | 400 | 400 | 400 | 500 | 500 |
| | temperature (° C.) | | | | | |
| | Immersion time | 90 | 90 | 90 | 30 | 30 |
| | (min) | | | | | |
| CS (MPa) | | 1012 | 1207 | 1185 | 938 | 1182 |
| CT (MPa) | | 56 | 58 | 67 | 40 | 60 |
| DOLzero (μm) | | 87 | 121 | 103 | 43 | 54 |
| CT/DOLzero | | 0.644 | 0.479 | 0.650 | 0.930 | 1.111 |
| CS × DOLzero | | 4872 | 7018 | 6901 | 1720 | 3240 |
| CS/CT | | 18.1 | 20.8 | 17.7 | 23.5 | 19.7 |
| DOLzero/T (%) | | 15.8 | 17.8 | 18.7 | 7.2 | 7.9 |
| Drop test height | n1 | 75 | 80 | 95 | 50 | 40 |
| (cm) | n2 | 105 | 75 | 80 | 50 | 55 |
| | n3 | 75 | 90 | 75 | 65 | 45 |
| | Max | 105 | 90 | 95 | 65 | 55 |
| | Min | 75 | 75 | 75 | 50 | 40 |
| | Ave | 85 | 82 | 83 | 55 | 47 |

Although some embodiments and/or examples of the present disclosure are described in detail above, those skilled in the art may easily apply many modifications to these exemplary embodiments and/or examples without substantial departure from the novel teachings and effects of the present disclosure. Therefore, these modifications are within the scope of the present disclosure.

The documents described in this specification and the entire disclosure (including description, drawings, and claims) of the Japanese patent application specification, which is the basis for the priority of the present application under the Paris Convention, are incorporated herein by reference.

1. A reinforced crystallized glass, comprising:
a crystallized glass as a base material, the crystallized glass comprising, as expressed in terms of mol % on an oxide basis:
30.0% to 70.0% of an SiO₂ component,
8.0% to 25.0% of an Al₂O₃ component,
2.0% to 25.0% of an Na2O component,
1.0% to 6.0% of an Li₂O component,
0% to 25.0% of an MgO component,
0% to 30.0% of a ZnO component, and
0% to 10.0% of a TiO₂ component,
wherein a surface of the reinforced crystallized glass is formed with a compressive stress layer, and
a depth (DOLzero) of the compressive stress layer is 60 μm or more.

2. The reinforced crystallized glass according to claim 1, wherein a value of a total content of the MgO component and the ZnO component is 1.0% or more and 30.0% or less, as expressed in terms of mol % on an oxide basis.

3. The strengthened crystallized glass according to claim 1, wherein the crystallized glass comprises, as expressed in terms of mol % on an oxide basis:
0% to 25.0% of a B₂O₃ component,
0% to 10.0% of a P₂O₅ component,
0% to 20.0% of a K₂O component,
0% to 10.0% of a CaO component,
0% to 10.0% of a BaO component,
0% to 8.0% of a FeO component,
0% to 10.0% of a ZrO₂ component, and
0% to 5.0% of an SnO₂ component.

4. The strengthened crystallized glass according to claim 1, wherein the crystallized glass comprises, as expressed in terms of mol % on an oxide basis:
0% to 10.0% of an SrO component,
0% to 3.0% of an La₂O₃ component,
0% to 3.0% of a Y₂O₃ component,
0% to 5.0% of an Nb₂O₅ component,
0% to 5.0% of a Ta₂O₅ component, and
0% to 5.0% of a WO₃ component.

5. The strengthened crystallized glass according to claim 1, wherein a content of the B₂O₃ component in the crystallized glass is 0.0% or more and less than 2 0%, as expressed in terms of mass % on an oxide basis.

6. The strengthened crystallized glass according to claim 1, wherein a value of a molar ratio [TiO₂/Na₂O] of the TiO₂ component relative to the Na₂O component is 0 or more and 0.41 or less, as expressed in terms of mol % on an oxide basis.

7. The strengthened crystallized glass according to claim 1, wherein a surface compressive stress value (CS) of the compressive stress layer is 800 MPa or more.
